(19) United States
(12) Patent Application Publication
(10) Pub. No.: US 2006/0243350 A1
(43) Pub. Date: Nov. 2, 2006

(54) Display device for woodworking machine

(75) Inventor: Yen-Chih Chang, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORPORATION LTD., TAICHUNG HSIEN (TW)

(21) Appl. No.: 11/357,095

(22) Filed: Feb. 21, 2006

(30) Foreign Application Priority Data
Feb. 21, 2005 (TW) 94105111

(51) Int. Cl. B23Q 16/00

(52) U.S. Cl. 144/420

(57) ABSTRACT

The present invention is a display device having a control circuit, a position detector, a converting circuit and a display circuit. The control circuit is provided for computing and processing data. The position detector is mounted on a woodworking machine and connects with the control circuit for detecting a position of a blade of the woodworking machine and transmitting signals to the control circuit. The converting circuit is coupled with the control circuit for receiving and converting the signals from the position detector into digital signals. The control circuit computes frequency variation of the digital signals from said converting circuit and based on a relation to convert the digital signals to a position information. The display circuit connects with the control circuit for showing the position information.

### BACKGROUND OF THE INVENTION

1. Field of the Invention

The present invention relates generally to woodworking machines, and more particularly, to a display device for displaying a position information with respect to a blade of a woodworking machine.

2. Description of the Related Art

Among conventional processing machines used in household or general factories, woodworking machines are widely applied. A common woodworking machine usually includes an adjusting device for changing height, angle, or distance of a blade of the woodworking machine when specific processing.

The above woodworking machine can be based on the processing type, such as milling or cutting, of a workpiece to adjustably operated in height, angle, or distance of the blade. However, the conventional method for adjusting height, angle, and distance of the blade is mechanical, employing a scale and a pointer to indicate a specific value, rather than digital. That brings inconvenience of prompt measurement and is not clear enough.

### SUMMARY OF THE INVENTION

The objective of the present invention is to provide a display device for displaying a position of a blade of a woodworking machine, wherein the display device digitally shows height, angle, or distance of the blade in the woodworking machine for further prompt adjustment.

The objective of the present invention is attained by the display device having a control circuit, a position detector, a converting circuit and a display circuit. The control circuit is provided for computing and processing data. The position detector is mounted on the woodworking machine and connects with the control circuit for detecting the position of the blade and transmitting signals to the control circuit. The converting circuit is coupled with the control circuit for receiving and converting the signals from the position detector into digital signals. The control circuit computes frequency variation of the digital signals from said converting circuit and based on a relation to convert the digital signals to a position information. The display circuit connects with the control circuit for showing the position information to a user.

By the means, the user can quickly read the position of the blade through the digital display.

### BRIEF DESCRIPTION OF THE DRAWINGS

FIG. 1 is a circuit diagram of the display device of the present invention.

FIG. 2 is a block schematic diagram of the display device of the present invention.

### DETAILED DESCRIPTION OF PREFERRED EMBODIMENTS

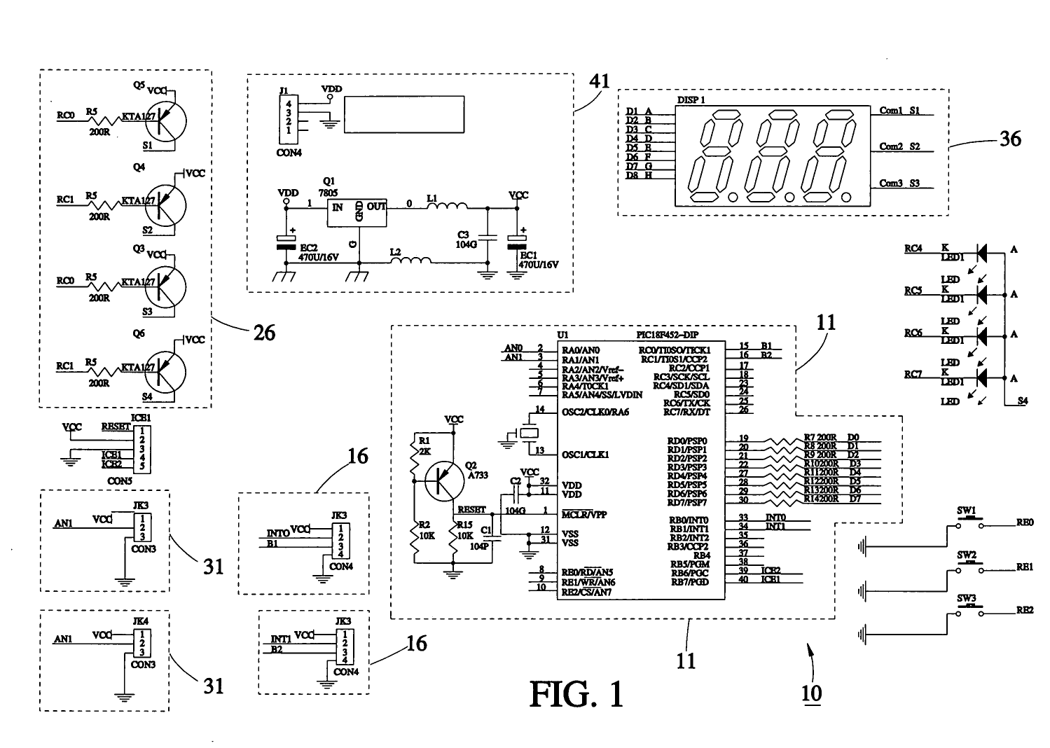

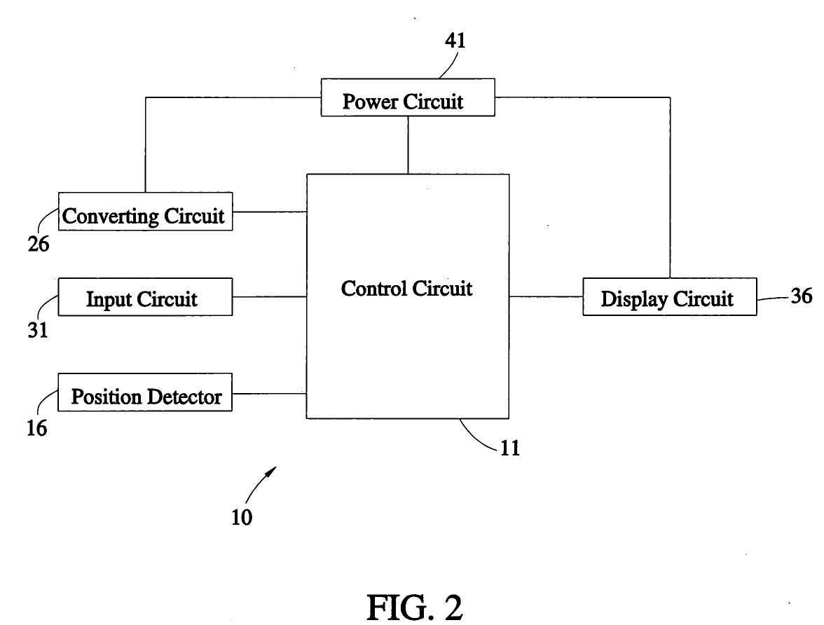

Referring to FIGS. 1-2, a display device 10 for displaying a position information with respect to a blade of a woodworking machine, constructed according to a preferred embodiment of the present invention, is composed of a control circuit 11, one position detector 16, a converting circuit 26, an input circuit 31, a display circuit 36, and a power circuit 41.

The control circuit 11 is a single-chip system in the embodiment for computing and processing data.

The position detector 16 is a photointerrupter in this embodiment. The position detector 16 is mounted on the woodworking machine and connected with the control circuit 11. The position detector 16 detects a variation of an adjustor for moving the position of the blade and then transmits voltage signals corresponding to the variation of the adjustor to the control circuit 11. The position can be a height, an angle, or a distance of the blade within the woodworking machine.

The converting circuit 26 is coupled with the control circuit 11 for receiving the signals transmitted from the position detector 16 and then converting the signals into digital signals.

The input circuit 31 is a membrane switch in this embodiment and connected with the control circuit 11. The input circuit 31 respectively transmits a starting signal and an ending signal by a user's operation to the control circuit 11. The control circuit 11 computes the relation between the variation of the adjustor and the position of the blade, based on the signals transmitted by the position detector 16 during from the starting signal to the ending signal.

The display circuit 36 is applied to a liquid crystal display (LCD) in this embodiment and connects to the control circuit 11. After the control circuit 11 processes the digital signals converted by the converting circuit 26, the display circuit 36 shows a position information corresponding to the digital signals.

The power circuit 41 provides the converting circuit 26, the control circuit 11, and the display circuit 36 with direct current (DC) power as a basic voltage, which can alternatively be alternate current (AC) power under rectification and voltage drop or battery DC power.

After the control circuit 11 decides the relation between the variation of the adjustor and the position of the blade, when the user moves the adjustor, the position detector 16 detects the variation of the adjustor and transmits corresponding the voltage signals to the control circuit 11. The converting circuit 26 receives the voltage signals and converting them into the digital signals. The control circuit 11 gets the digital signals to compute the frequency variation of the digital signals and then based on the relation to convert the digital signals to the position information. The display circuit 36 shows the position information to the user.

As indicated above, the present invention employs an open-loop control to display the value of the height, angle or distance of the blade, wherein the position detector 16 notifies the control circuit 11 of the variation of the height, angle, and distance by feedback to enable the control circuit 11 to get the current height, angle, and distance.

Because the control circuit 11 is a single-chip system for providing a programmable control process, having better comprehensive applications, the present invention can be applied to any of woodworking machines and portable machine tools, which is adjustable in height, angle, or distance of a blade. In addition, the present invention has not seen in the filed of the woodworking machines and portable machine tools.

In the embodiment, the position detector 16 of the present invention can alternatively be a varistor, an encoder, a Hall device, or a photoreceptor. The input circuit 31 can be a potentiometer. The display circuit 36 can be a seven-segment display device.

While the embodiment of the invention has been illustrated and described, it is not intended that the embodiment illustrates and describes all possible forms of the invention. Rather, the words used in the specification are words of description rather than of limitation; and it should be understood that various changes may be made without departing from the spirit and scope of the invention.

What is claimed is:

1. A display device for displaying a position of a blade of a woodworking machine, comprising:
a control circuit for computing and processing data;
a position detector mounted on said woodworking machine and connecting with said control circuit for detecting the position of the blade and transmitting voltage signals to said control circuit;
a converting circuit coupling with said control circuit for receiving said voltage signals from said position detector and converting said voltage signals into digital signals; and
a display circuit connecting with said control circuit for displaying a position information generated by the control circuit and corresponding to said digital signals;
wherein said control circuit computes frequency variation of the digital signals from said converting circuit and based on a relation to convert the digital signals to the position information.

2. The display device as defined in claim 1, further comprising an input circuit connecting with said control circuit for generating a starting signal and an ending signal respectively, wherein the control circuit computes the relation based on the signals transmitted by the position detector during from the starting signal to the ending signal.

3. The display device as defined in claim 1, wherein said position detector is a photointerrupter.

4. The display device as defined in claim 1, wherein said input circuit is a membrane switch.

5. The display device as defined in claim 1, wherein said control circuit is a single-chip system.

6. The display device as defined in claim 1, wherein said display circuit is applied to a liquid crystal display.

7. The display device as defined in claim 1, wherein the position of the blade is one of height, angle, and distance of the blade in woodworking machine.
